(19) United States
(12) Patent Application Publication
(10) Pub. No.: US 2006/0054200 A1
(43) Pub. Date: Mar. 16, 2006

(54) Dishwasher

(75) Inventors: Byoung Wook Min, Seoul (KR); Byung Hwan Ahn, Changwon-si (KR); Hung Myong Cho, Gimhae-si (KR); Cha Seung Jun, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/061,737

(22) Filed: Feb. 22, 2005

(30) Foreign Application Priority Data
Sep. 16, 2004 (KR) P2004-74093

(51) Int. Cl. B08B 3/00

(52) U.S. Cl. 134/56 D; 134/58 D

(57) ABSTRACT

The present invention provides a dishwasher, by which an assembly of a sump and washing motor is structurally improved. The present invention includes a sump storing water therein, the sump having a shaft coupling hole coupled with a washing motor shaft, at least one or more guide pieces outwardly projected from one surface of the sump, and a washing motor having a guide groove receiving the at least one or more guide pieces therein.

This application claims the benefit of the Korean Application No. P2004-74093 filed on Sep. 16, 2004, which is hereby incorporated by reference.

### BACKGROUND OF THE INVENTION

1. Field of the Invention

The present invention relates to a dishwasher, and more particularly, to an improved assembly of a sump and a washing motor.

2. Discussion of the Related Art

Generally, a dishwasher is an apparatus for washing used tableware such as a dish and the like automatically. The dishwasher automatically performs dishwashing to enhance user's convenience and recently becomes more popular.

A dishwasher according to a related art is explained with reference to the attached drawings as follows.

FIG. 1 is a schematic cross-sectional diagram of a dishwasher according to a related art.

Referring to FIG. 1, in a dishwasher according to a related art, a tub 10 is provided as a washing chamber, in which dishes are washed, within a body 1.

A sump 20 is provided to a bottom of the tub 10 to store and circulate water necessary for dishwashing. And, a washing motor 40 is installed beneath the sump 20.

A pair of spray arms 30 are rotatably provided to lower and upper parts of the tub 10 to spray water, respectively.

The sprays arms 30 are connected to the sump 20 via upper and lower connecting pipes 32, respectively to be supplied with water. A multitude of spray holes (not shown in the drawing) are formed at each upper part of the spray arms 30. The spray holes (not shown in the drawing) are provided to spray the water in various directions.

And, a rack 34 is provided over each of the spray arms 30 to receive dishes to be washed.

The sump 20 pumps the water to supply to the spray arms 30, collects the water sprayed within the tub 10, and filters the collected water.

FIG. 2 is an exploded diagram of the sump in FIG. 1.

Referring to FIG. 2, a water receiving portion 22 is concavely formed at a central part of the sump 20 to store water therein.

And, a washing motor 40, which is coupled with the sump 20 to provide a drive force for circulating water, is generally provided to a bottom of the water receiving portion 22.

FIG. 3 is a perspective bottom diagram of the sump in FIG. 1.

Referring to FIG. 3, in order to assemble the washing motor 40 to the sump, a shaft coupling hole 24 is formed at a central part of the water receiving portion 22 to be penetrated by a rotational shaft of the washing motor 40.

And, a plurality of screw locking bosses 26 for screw locking to the washing motor 40 are downwardly provided to a bottom of the water receiving portion 22.

Referring to FIG. 2 and FIG. 3, screw locking holes 46 are formed at the washing motor 40 to correspond to the screw locking bosses 26, respectively. The rotational shaft 44 of the washing motor 40 penetrates the shaft coupling hole 24 of the sump 20 to be coupled with other parts such as a disposer (not shown in the drawing), an impeller (not shown in the drawing), and the like. And, locking screws (not shown in the drawing) are locked to the screw locking holes 46 of the washing motor 40 and the screw locking bosses 26 of the sump 20, respectively, whereby the washing motor 40 is fixed to the sump 20.

The disposer is a device for grinding garbage collected in the sump, and the impeller is a device for pumping the water.

A sealing member 50 is provided to a top surface of the shaft coupling hole 24 of the sump 20 to enable a rotation of the shaft 44 and to perform water-tightness between the rotational shaft 44 of the washing motor 40 and the shaft coupling hole 24.

And, the sump 20 is provided with a passage diverting motor 62 controlling a direction of a passage of the water and a drain motor 64 for draining the water.

However, the mounting structure of the washing motor of the dishwasher according to the related art has the following problems or disadvantages.

First of all, in mounting the sump with the washing motor, the screw locking is performed after the screw locking holes are aligned with the screw locking bosses. Yet, it is difficult to perform the locking work while the alignment between the screw locking holes and the screw locking bosses is maintained. Hence, working convenience is poor.

Secondly, the washing motor assembled to the sump is relatively heavy so that the bottom of the sump sinks downward. And, a couple of forces generated from a rotational force generated from driving the washing motor distorts the bottom of the sump as well.

### SUMMARY OF THE INVENTION

Accordingly, the present invention is directed to a dishwasher that substantially obviates one or more problems due to limitations and disadvantages of the related art.

An object of the present invention is to provide a dishwasher, by which an assembly of a sump and washing motor is structurally improved.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher according to the present invention includes a sump storing water therein, the sump having a shaft coupling hole coupled with a washing motor shaft, at least one or more guide pieces outwardly projected from one surface of the sump, and a washing motor having a guide groove receiving the at least one or more guide pieces therein.

In another aspect of the present invention, a dishwasher includes a sump storing water therein, the sump having a shaft coupling hole provided to a central part of a bottom of the sump to be coupled with a washing motor shaft wherein at least one or more guide pieces are downwardly projected from a shaft coupling hole outside area of the bottom, a washing motor having a guide groove receiving the at least one or more guide pieces therein, and at least one or more rigidity reinforcement ribs provided to the bottom of the sump contacting with the washing motor.

In another aspect of the present invention, a dishwasher includes a sump storing water therein, the sump having a shaft coupling hole provided to a central part of a bottom of the sump to be coupled with a washing motor shaft, a sealing member provided in the vicinity of the shaft coupling hole of the sump, a washing motor coupled with the bottom of the sump, and at least one or more rigidity reinforcement ribs provided to the bottom of the sump contacting with the washing motor.

In another aspect of the present invention, a dishwasher includes a sump storing water therein, the sump having a shaft coupling hole provided to a central part of a bottom of the sump to be coupled with a washing motor shaft, a sealing member provided in the vicinity of the shaft coupling hole of the sump, a washing motor having a guide groove receiving the at least one or more guide pieces therein, and at least one or more rigidity reinforcement ribs provided to the bottom of the sump contacting with the washing motor, wherein a sealing member seat is provided in the vicinity of the shaft coupling hole of the sump to load the sealing member thereon.

In a further aspect of the present invention, a dishwasher includes a sump storing water therein, the sump having a shaft coupling hole provided to a central part of a bottom of the sump to be coupled with a washing motor shaft wherein at least one or more guide pieces are downwardly projected from a shaft coupling hole outside area of the bottom, a sealing member provided in the vicinity of the shaft coupling hole of the sump, a washing motor having a guide groove receiving the at least one or more guide pieces therein, and at least one or more rigidity reinforcement ribs provided to the bottom of the sump contacting with the washing motor, wherein a sealing member seat is provided in the vicinity of the shaft coupling hole of the sump to load the sealing member thereon.

Therefore, the present invention enhances working efficiency of assembling the washing motor to the sump.

And, the rigidity of the sump is raised to prevent the sump from being distorted or sinking downward due to the weight and rotational force of the washing motor.

Moreover, the sealing seat, on which the sealing member is loaded, is provided to the rim of the shaft coupling hole of the sump, whereby assembly efficiency of the sealing member is enhanced and whereby a space amounting to a height stepped downward can be secured.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic cross-sectional diagram of a dishwasher according to a related art;

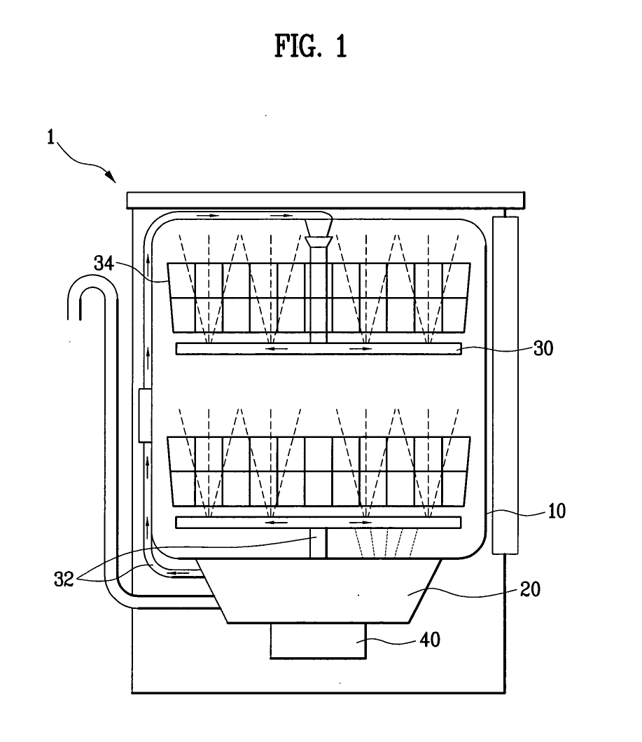

FIG. 2 is an exploded diagram of the sump in FIG. 1;

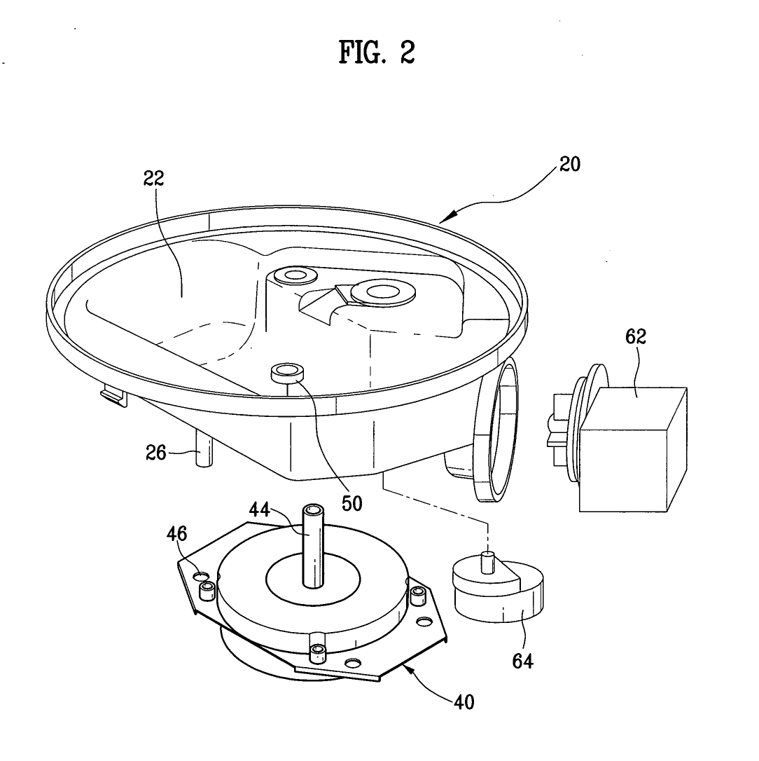

FIG. 3 is a perspective bottom diagram of the sump in FIG. 1;

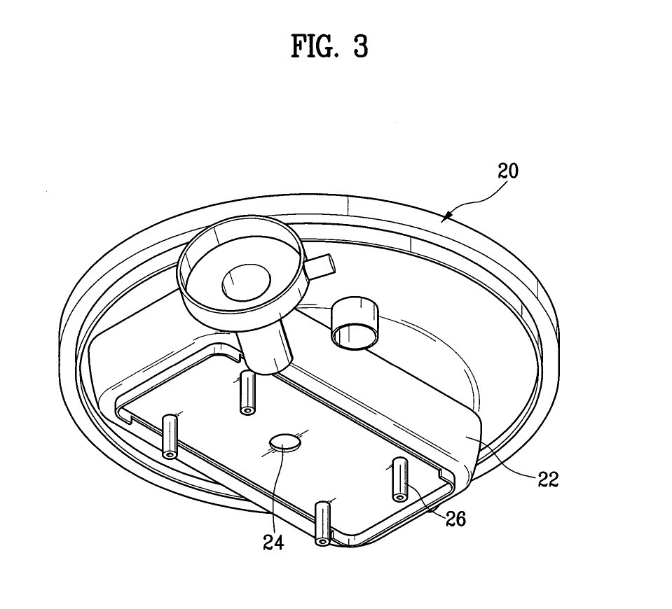

FIG. 4 is an exploded cross-sectional diagram of a coupling assembly of a sump and washing motor according to the present invention;

FIG. 5 is a perspective bottom diagram of the sump in FIG. 4; and

FIG. 6 is a perspective diagram of the washing motor in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

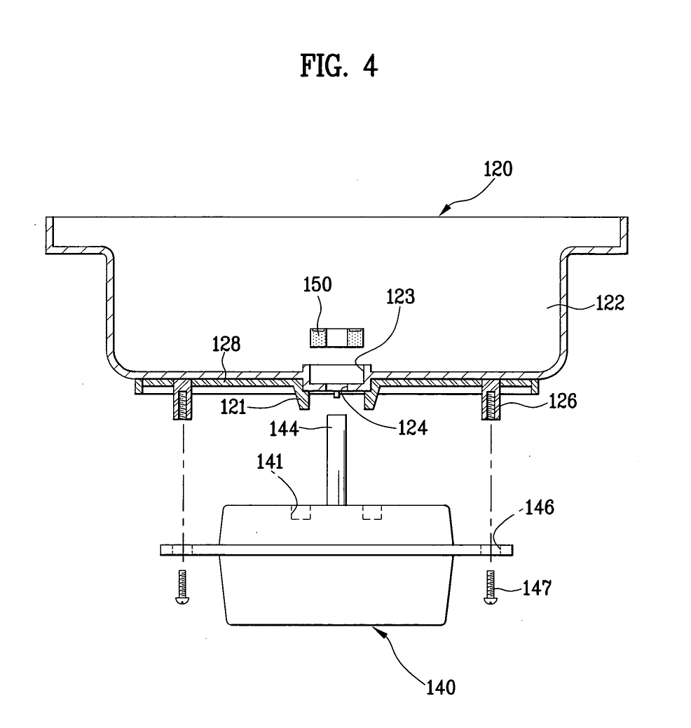

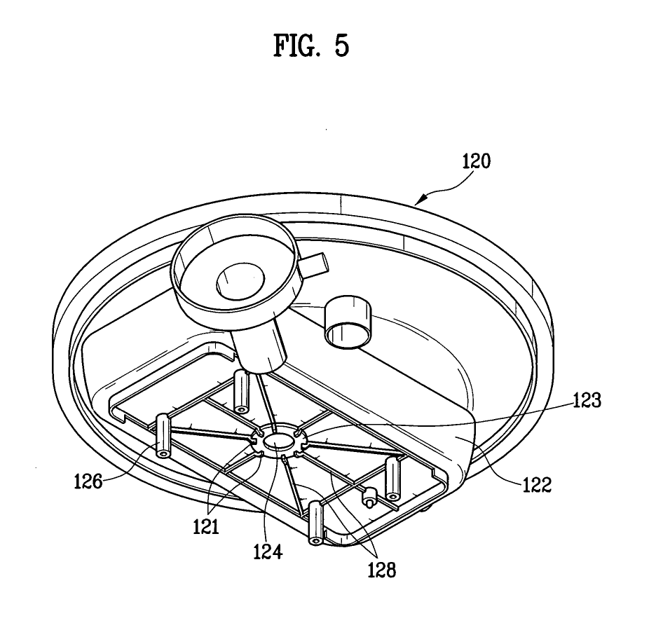

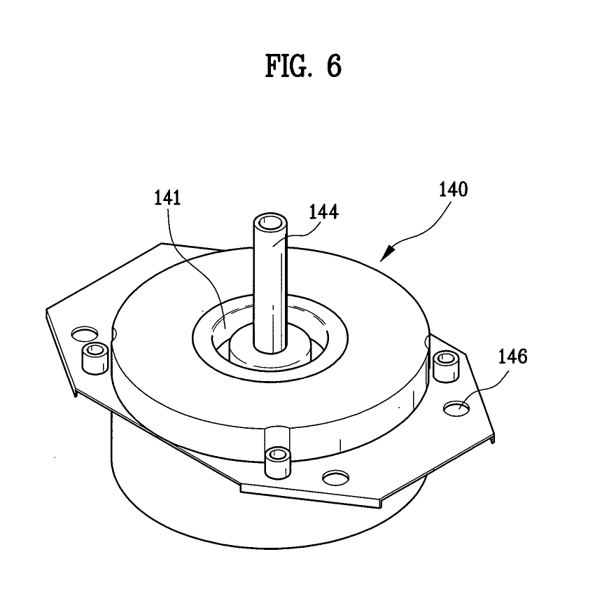

FIG. 4 is an exploded cross-sectional diagram of a coupling assembly of a sump and washing motor according to the present invention, FIG. 5 is a perspective bottom diagram of the sump in FIG. 4, and FIG. 6 is a perspective diagram of the washing motor in FIG. 4.

Referring to FIGS. 4 to 6, in a mounting structure of a washing motor of a dishwasher according to the present invention, a shaft coupling hole 124 is formed at a sump 120 as a space for storing water therein.

Namely, a washing motor providing a power for circulating the water in the sump 120 is coupled with a bottom of the sump 120. Specifically, the shaft coupling hole 124 is preferably provided to the bottom of a water receiving portion 122 formed at a recessed central part of the sump 120.

A plurality of guide pieces 121 are provided to the bottom of the sump 120 to be projected downward.

As the washing motor 140 is coupled with the sump 120 in a manner that a rotational shaft 144 of the washing motor 140 is inserted in the shaft coupling hole 124 of the sump 120, it is preferable that the guide pieces 121 are radially provided around the shaft coupling hole 124.

And, a guide groove 141 corresponding to the guide pieces 121 is provided to a top surface of the washing motor 140 coming contact with the bottom of the sump 120 to receive the guide pieces 121 when the washing motor 140 closely adheres to the bottom of the sump 120.

Preferably, a plurality of the guide pieces 121 are provided around the shaft coupling hole 124 to enclose the shaft coupling hole 124 and to leave a predetermined distance from the shaft coupling hole 124 each.

Hence, when the washing motor 140 is assembled to the bottom of the sump 120, the guide groove 141 receiving the guide pieces 121 is preferably formed to enclose the rotational shaft 144 and to leave a predetermined distance from the rotational shaft 144 that is inserted in the shaft coupling hole 124. More preferably, the guide groove 141 is formed to have a ring shape.

Preferably, each of the guide pieces 121, as shown in FIG. 4, has an inclined lateral side to facilitate the washing motor 140 to be guided in assembling the washing motor 140 to the sump 120.

Specifically, FIG. 4 shows that a lateral outside of each of the guide pieces 121 is inclined toward its central part in a manner that its outside diameter gradually decreases toward its lower end. Alternatively, a lateral inside of each of the guide pieces 121 is inclined toward its central part in a manner that its inside diameter gradually increases toward its lower end.

Preferably, an inner circumference of the guide groove 141 of the washing motor 140 is inclined to correspond to the guide pieces 121.

Meanwhile, a plurality of screw locking bosses 126 are provided downward to a bottom of the water receiving portion 122 for screw locking to the washing motor 140.

And, a plurality of screw locking holes 146 are provided to the washing motor 140 to correspond to the screw locking bosses 126, respectively.

When the washing motor 140 is assembled to the sump 120, the rotational shaft 144 of the washing motor 140 penetrates the shaft coupling hole 124 of the sump 120 and the guide pieces 121 of the sump 120 are fitted in the guide groove 141 of the washing motor 140 to align the assembled position of the washing motor 140.

In doing so, since the lateral outside of the guide piece 121 toward an outside of the sump 120 is inclined, the position alignment of the motor 140 is naturally guided when the guide pieces 121 are fitted in the guide groove 141.

Hence, the washing motor 140 can be pre-assembled to the sump 120 by the guide pieces 121 and the guide groove 141 to sustain its alignment state, which facilitates locking screws to be locked.

Once the locking screws 147 penetrate the screw locking holes 146 to be locked in the screw locking bosses 126 of the sump 120, respectively, the assembly of the washing motor 40 and the sump 120 is completed.

Meanwhile, the present invention further provides a rigidity reinforcement rib 128 to the sump 120 to raise rigidity of the sump 120.

As a part of the sump 120 to which the washing motor 140 is assembled is considerably distorted or transformed by the weight and rotational force of the washing motor 140, the rigidity reinforcement rib 128 is preferably provided to a surface to which the washing motor 140 is assembled.

In the embodiment of the present invention, the washing motor 140 is assembled to the bottom of the water receiving portion 122 of the sump 120. Hence, the rigidity reinforcement rib 128 is provided to the bottom of the water receiving portion 122.

Preferably, a plurality of rigidity reinforcement ribs 128 are radially provided centering around the shaft coupling hole 124 toward an outside of the sump 120.

In this case, a plurality of the rigidity reinforcement ribs 128 extend to a rim of the water receiving portion 122 and their tips are collectively connected to each other.

Alternatively, the rigidity reinforcement ribs 128 can be built in one body of the guide pieces 121. Namely, an inner end of the rigidity reinforcement rib 128 is preferably connected to an outer side of the corresponding guide piece 121.

Hence, the bottom of the sump 120 is prevented from being transformed by the weight or rotational force of the washing motor 140 since the rigidity reinforcement ribs 128 are provided to an assembled interface of the sump 120 with the washing motor 140.

According to the preferred embodiment of the present invention, a sealing member 150 enabling water-tightness of the water receiving portion 122 is preferably provided to the shaft coupling hole 124 in which the rotational shaft 144 of the washing motor 140 is fitted.

The sealing member 150 prevents the water within the water receiving portion 122 from leaking via the shaft coupling hole 124 and preferably has a ring shape to secure a rotation of the rotational shaft 144 of the washing motor 140.

The ring type sealing member 150 is installed over a top surface of the shaft coupling hole 124 so that the rotational shaft 144 is fitted therein.

And, a sealing member seat 123 that is stepped downward is preferably provided around the shaft coupling hole 124 at which the sealing member 150 is situated so that the sealing member 150 is loaded thereon.

Hence, after the rotational shaft 144 is fitted in the sealing member 150, the sealing member 150 is loaded on the sealing member seat 123 at the central part of the sump 120.

Therefore, the assembly efficiency of the sealing member 150 is enhanced. And, it is able to secure a space within the sump 120 as high as the downwardly stepped height of the sealing member seat 123.

Accordingly, the present invention provides the following effects or advantages.

First of all, in assembling the washing motor to the bottom of the sump, the alignment between the screw locking bosses and the screw locking holes is guided by the guide pieces at the bottom of the sump and the guide groove at the top surface of the washing motor to achieve the pre-assembly of the sump and washing motor, whereby the assembly efficiency is enhanced.

Secondly, the rigidity reinforcement ribs are provided to the bottom of the sump to which the washing motor is assembled, whereby the sump is prevented from being transformed by the weight and/or rotational force of the washing motor.

Thirdly, since the sealing member seat is recessed around the shaft coupling hole of the sump, the assembly efficiency of the sealing member is enhanced and the space amounting to the recessed stepped height can be secured.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a sump storing water therein, the sump having a shaft coupling hole coupled with a washing motor shaft;
at least one or more guide pieces outwardly projected from one surface of the sump; and
a washing motor having a guide groove receiving the at least one or more guide pieces therein.

2. The dishwasher of claim 1, wherein the shaft coupling hole is provided to a bottom of the sump.

3. The dishwasher of claim 1, wherein the at least one or more guide pieces are provided in the vicinity of the shaft coupling hole.

4. The dishwasher of claim 3, wherein the guide pieces are plurally provided to leave a prescribed interval from each other and to enclose the shaft coupling hole.

5. The dishwasher of claim 1, wherein the guide groove has a ring shape centering on a center of a top surface of the washing motor.

6. The dishwasher of claim 1, wherein one lateral side of the at least one guide piece inclines.

7. The dishwasher of claim 6, wherein a lateral outside of the guide piece inclines toward a center so that an outside diameter gradually decreases toward a lower end.

8. The dishwasher of claim 1, wherein at least one or more rigidity reinforcement ribs are provided to a bottom of the sump contacting with the washing motor.

9. The dishwasher of claim 8, wherein the at least one or more rigidity reinforcement ribs are provided to the bottom of the sump.

10. The dishwasher of claim 8, wherein a plurality of the rigidity reinforcement ribs are radially provided centering on the shaft coupling hole.

11. The dishwasher of claim 10, wherein outer ends of the rigidity reinforcement ribs are collectively connected to one another.

12. The dishwasher of claim 1, wherein a sealing member is further provided in the vicinity of the shaft coupling hole of the sump.

13. The dishwasher of claim 12, wherein a sealing member seat is provided in the vicinity of the shaft coupling hole of the sump to load the sealing member thereon.

14. The dishwasher of claim 13, wherein the sealing member seat is downwardly stepped.

15. A dishwasher comprising:
a sump storing water therein, the sump having a shaft coupling hole provided to a central part of a bottom of the sump to be coupled with a washing motor shaft wherein at least one or more guide pieces are downwardly projected from a shaft coupling hole outside area of the bottom;
a washing motor having a guide groove receiving the at least one or more guide pieces therein; and
at least one or more rigidity reinforcement ribs provided to the bottom of the sump contacting with the washing motor.

16. The dishwasher of claim 15, wherein the at least one or more guide pieces are provided in the vicinity of the shaft coupling hole.

17. The dishwasher of claim 16, wherein the guide pieces are plurally provided to leave a prescribed interval from each other and to enclose the shaft coupling hole.

18. The dishwasher of claim 15, wherein the guide groove has a ring shape centering on a center of a top surface of the washing motor.

19. The dishwasher of claim 15, wherein one lateral side of the at least one guide piece inclines.

20. The dishwasher of claim 15, wherein a lateral outside of the guide piece inclines toward a center so that an outside diameter gradually decreases toward a lower end.

21. The dishwasher of claim 15, wherein a plurality of the rigidity reinforcement ribs are radially provided.

22. The dishwasher of claim 15, wherein outer ends of the rigidity reinforcement ribs are collectively connected to one another.

23. The dishwasher of claim 15, wherein a sealing member is further provided in the vicinity of the shaft coupling hole of the sump.

24. The dishwasher of claim 15, wherein a sealing member seat is provided in the vicinity of the shaft coupling hole of the sump to load the sealing member thereon.

25. The dishwasher of claim 24, wherein the sealing member seat is downwardly stepped.

26. A dishwasher comprising:
a sump storing water therein, the sump having a shaft coupling hole provided to a central part of a bottom of the sump to be coupled with a washing motor shaft;
a sealing member provided in the vicinity of the shaft coupling hole of the sump;
a washing motor coupled with the bottom of the sump; and
at least one or more rigidity reinforcement ribs provided to the bottom of the sump contacting with the washing motor.

27. A dishwasher comprising:
a sump storing water therein, the sump having a shaft coupling hole provided to a central part of a bottom of the sump to be coupled with a washing motor shaft;
a sealing member provided in the vicinity of the shaft coupling hole of the sump;
a washing motor having a guide groove receiving the at least one or more guide pieces therein; and
at least one or more rigidity reinforcement ribs provided to the bottom of the sump contacting with the washing motor,
wherein a sealing member seat is provided in the vicinity of the shaft coupling hole of the sump to load the sealing member thereon.

28. A dishwasher comprising:
a sump storing water therein, the sump having a shaft coupling hole provided to a central part of a bottom of the sump to be coupled with a washing motor shaft wherein at least one or more guide pieces are downwardly projected from a shaft coupling hole outside area of the bottom;
a sealing member provided in the vicinity of the shaft coupling hole of the sump;
a washing motor having a guide groove receiving the at least one or more guide pieces therein; and
at least one or more rigidity reinforcement ribs provided to the bottom of the sump contacting with the washing motor,
wherein a sealing member seat is provided in the vicinity of the shaft coupling hole of the sump to load the sealing member thereon.
